(19) United States
(12) Patent Application Publication
(10) Pub. No.: US 2009/0111495 A1
(43) Pub. Date: Apr. 30, 2009

(54) RETREIVING AND PRESENTING INFORMATION IN A PORTABLE DEVICE

(75) Inventors: Fredrik Sjolin, Ronneby (SE); Laurent Mauvais, Karlskrona (SE); Mats Hellman, Karlskrona (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: UIQ TECHNOLOGY AB, Ronneby (SE)

(21) Appl. No.: 12/295,752

(22) PCT Filed: Apr. 4, 2007
(86) PCT No.: PCT/SE2007/000325

§ 371 Date: Oct. 2, 2008

(30) Foreign Application Priority Data
Apr. 4, 2006 (GB) 0606799.5
Apr. 7, 2006 (GB) 0607069.2

(51) Int. Cl. H04W 4/00; H04M 1/00; G06F 17/30

(52) U.S. Cl. 455/466; 455/550.1; 707/100; 707/E17.044

(57) ABSTRACT

The present invention is related to a method for retrieving contacts in a portable device being arranged to operatively communicate messages and being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device. The portable is arranged to perform the method, which is characterized by the steps of: monitoring the number of messages that are communicated with the device for each contact in a set of contacts among said plurality of contacts; sorting said set of contacts with respect to the number of times each contact has been involved in the communication of a message; presenting the sorted set of contacts on the presentation arrangement.

### TECHNICAL FIELD

The present invention relates to the field of portable devices, and particularly to retrieving and presenting information in portable communication devices. Even more particular the invention relates to a method of for retrieving and presenting contacts in a portable communication device, a portable communication device adapted to operatively provide such retrieving and presenting as well as a computer program product for performing the method in a portable communication device.

### BACKGROUND OF THE INVENTION

It is well known to those skilled in the art of portable communication devices that such devices are provided with various types of user interfaces for receiving and/or presenting information, e.g. key pads and displays etc. Typically the information to be presented are stored in data files or similar which can be created and/or modified by the portable communication device itself, e.g. by means of input on a key pad or similar arranged on the portable device. In addition, various data files may be downloaded by means of wire or wireless communication into the portable device from other devices. These features are well known to those skilled in the art.

Typically, most users require that data files or entries in data files of portable communication devices can be managed for different purposes, e.g. for editing, renaming, copying and/or deleting etc. This is particularly so with respect to so-called address books comprising contacts associated with contact addresses that a user of the portable communication device may use to contact other persons and/or companies or similar entities etc.

The current paradigms for contacts in portable devices is in general allowing users to maintain an address book which i.a. comprises contact addresses such as telephone numbers, fax numbers, email addresses and geographical addresses etc for each contact.

Such address books are usually sorted alphabetically in name order. Locating a specific contact requires the user either to initiate a search through the entire address book or to use methods such as alphabetical index tabs to locate the name they need.

However, these operations are not as straightforward as it may sound.

Portable devices are typically provided with comparatively small displays (e.g. a few inches such as about 1, 2 or 3 inches). In addition, portable devices are generally providing a reduced functionality for browsing and selecting, typically being implemented by means of a few keys on a key pad which results in a more or less stepwise movement of a cursor or similar from one contact to another in an address book. Hence, a user of a portable device is typically limited to view a small number of contacts on a comparatively small display and to move fairly slowly and substantially stepwise among the displayed contacts.

I addition, users of portable devices that comprise an address book are often inconsistent in the way they enter names and similar contact information into the address book. For example, some contacts may be entered in the address book with first name and last name in separate fields, whereas other contacts may be entered with the first and last name in a single field. Moreover, some contacts may be entered with a first name only and the use of initials to substitute portions of names is not uncommon. Hence, the current system of maintaining an alphabetically sorted address book is not optimally efficient, nor does it offer a compelling user experience.

In view of the above it would be beneficial to provide a more efficient manner for retrieving and selecting contacts in an address book or similar in a portable communication device.

### SUMMARY OF THE INVENTION

The present invention is directed to solving the problem of providing a more efficient manner for retrieving and selecting contacts in an address book or similar in a portable communication device.

One object of the present invention is thus to provide a more efficient manner for retrieving and selecting contacts in an address book in a portable communication device.

This object is achieved according to a first aspect of the present invention directed to a method for retrieving contacts in a portable device being arranged to operatively communicate messages and being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device, which portable device is arranged to perform the method.

The method is characterized by the steps of:
monitoring the number of messages that are communicated with the device for each contact in a set of contacts among said plurality of contacts;
sorting said set of contacts with respect to the number of times each contact has been involved in the communication of a message;
presenting the sorted set of contacts on the presentation arrangement.

A second aspect of the invention is directed to a method including the steps in the first aspect wherein the portable device is provided with an input arrangement and the method comprises the steps of selecting a contact among the presented contacts by receiving input from the input arrangement being actuated by a user of the portable device.

A third of the invention is directed to a method including the steps in the first aspect and comprising the steps of registering the point in time when messages are communicated with the device for each contact in the set of contacts, and sorting said set of contacts with respect to the number of times each contact has been involved in the communication of a message during a determined period of time.

A fourth aspect of the invention is directed to a method including the steps in the first or third aspect, and wherein the messages that are communicated with the device are sent from the device.

A fifth aspect of the invention is directed to a method including the steps in the first or third aspect, and wherein the messages that are communicated with the device are sent from the device and/or received by the device.

A sixth aspect of the invention is directed to a method including the steps in the first aspect, and wherein the messages that are communicated with the device are of at least two different types.

A seventh aspect of the invention is directed to a method including the steps in the sixth aspect, and wherein the messages that are communicated with the device are of at least two different types among: a Short Message Service message (SMS), an Instant Messaging message (IM), an Multimedia Messaging Service (MMS), an e-mail message, a fax message or a phone call message.

An eight aspect of the invention is directed to a method including the steps in the first aspect, and wherein one or several contacts among said plurality of contacts are excluded from said set of contacts, or at least from one of said sorting or said presenting.

A ninth aspect of the invention is directed to a method including the steps in the first or third aspect, and wherein the sorted set of contacts are presented in ascending or descending order depending on the number of messages that are communicated with the device for each contact.

The object mentioned above is also achieved by means of a tenth aspect of the present invention which provides a portable device being arranged to operatively communicate messages and being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device.

The portable device is arranged to retrieve contacts by being operatively arranged to:
monitor the number of messages that are communicated with the device for each contact in a set of contacts among said plurality of contacts;
sort said set of contacts with respect to the number of times each contact has been involved in the communication of a message;
present the sorted set of contacts on the presentation arrangement.

An eleventh aspect of the invention is directed to a portable device including the features of the tenth aspect, and wherein the portable device is provided with an input arrangement, and wherein the portable device is arranged to operatively select a contact among the presented contacts by receiving input from the input arrangement being actuated by a user of the portable device.

A twelfth aspect of the invention is directed to a portable device including the features of the tenth aspect, and wherein the portable device is arranged to operatively register the point in time when messages are communicated with the device for each contact in the set of contacts, and to operatively sort the set of contacts with respect to the number of times each contact has been involved in the communication of a message during a determined period of time.

A thirteenth aspect of the invention is directed to a portable device including the features of the tenth or twelfth aspect, and wherein the portable device is arranged to operatively communicate messages by sending messages.

A fourteenth aspect of the invention is directed to a portable device including the features of the tenth or twelfth aspect, and wherein the portable device is arranged to operatively communicate messages by sending messages and/or receiving messages.

A fifteenth aspect of the invention is directed to a portable device including the features of the tenth aspect, and wherein the portable device is arranged to operatively communicate messages of at least two different types.

A sixteenth aspect of the invention is directed to a portable device including the features of the fifteenth aspect, and wherein the portable device is arranged to operatively communicate messages of at least two different types among: a Short Message Service message (SMS), an Instant Messaging message (IM), an Multimedia Messaging Service (MMS), an e-mail message, a fax message or a phone call message.

A seventeenth aspect of the invention is directed to a portable device including the features of the tenth aspect, and wherein the portable device is arranged to operatively exclude one or several contacts among said plurality of contacts from said set of contacts, or at least from one of said sorting or said presenting.

An eighteenth aspect of the invention is directed to a portable device including the features of the tenth or twelfth aspect, and wherein the portable device is arranged to operatively present the sorted set of contacts in ascending or descending order depending on the number of messages that are communicated with the device for each contact.

A nineteenth aspect of the invention is directed to a computer program product stored on a computer usable medium, comprising readable program means for causing a portable device to execute, when said program means is loaded in the portable device being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device, the steps of:
monitoring the number of messages that are communicated with the device for each contact in a set of contacts among said plurality of contacts;
sorting said set of contacts with respect to the number of times each contact has been involved in the communication of a message;
presenting the sorted set of contacts on the presentation arrangement.

A twentieth aspect of the invention is directed to a computer program element having a program recorded thereon, where the program is to make a portable device to execute, when said program means is loaded in the portable device being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device, the steps of:
monitoring the number of messages that are communicated with the device for each contact in a set of contacts among said plurality of contacts;
sorting said set of contacts with respect to the number of times each contact has been involved in the communication of a message;
presenting the sorted set of contacts on the presentation arrangement.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasized that any methods defined by the appended claims may comprise further steps in addition to those presented in the claims. Moreover, without departing from the present invention, the steps in the claims may be performed in another order than the order in which they are presented in the claims.

### BRIEF DESCRIPTION OF THE DRAWINGS

The present invention will now be described in more detail with reference to the enclosed drawings, in which:

FIG. 1 is a schematic illustration of an exemplifying portable communication device in the form of a cell phone,

FIG. 2 is a schematic illustration of the cell phone in FIG. 1 connected to an exemplifying communication network,

FIG. 3 is a schematic illustration of the relevant interior parts of the cell phone in FIG. 1,

FIG. 4 is a flowchart illustrating an exemplifying method according to an embodiment of the present invention implemented by means of the cell phone in FIG. 1-3,

FIG. 5 shows a CD ROM on which program code for executing the method according to the invention is provided.

### DETAILED DESCRIPTION OF PREFERRED EMBODIMENTS

The present invention relates to portable devices having access to a plurality of so-called contacts where each contact is associated with one or several contact addresses that a user of the portable device may e.g. utilize for communicating with the contact in question. The contact may e.g. be a physical person or a company or an organisation or similar.

The contacts may e.g. be provided in an electronic address book comprising contact addresses in the form of e.g. telephone numbers, fax numbers, email addresses and/or geographical addresses etc for each contact in the address book. Such electronic address books are well known per se to those skilled in the art and they are commonly used e.g. in connection with modern cellular phones etc.

It should be emphasised that the contacts in an electronic address book or similar may be associated with other contact addresses than those mentioned above. Other contact addresses may e.g. be IP-addresses or similar addresses enabling a user of a portable device to communicate with a contact in the form of a server or similar connected to the Internet or some other data network.

As the observant reader realizes, the invention is particularly but not exclusively related to portable communication devices comprising contacts e.g. provided in the form of an electronic address book or similar, as is common in connection with e.g. modern cell phones.

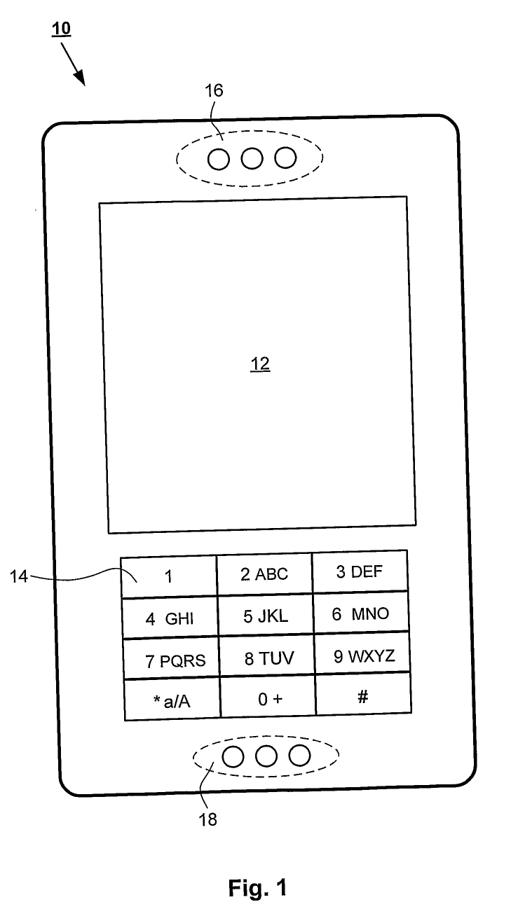

FIG. 1 shows a portable communication device 10 according to a preferred embodiment of the present invention. The portable communication device is preferably a cellular phone 10 having a presentation arrangement in the form of a display 12 and an input arrangement in the form of a keypad 14 comprising a number of keys. The keys of the keypad 14 are used for entering information such as selecting functions and responding to prompts, and the display 12 is used for displaying functions and prompts to a user of the phone 10. The keypad 14 may be any suitable keypad, e.g. comprising push buttons and/or touch buttons or similar. In addition, the phone 10 includes a speaker 16 for presenting sounds to a user and a microphone 18 for sensing the voice from a user. Moreover, the phone 10 includes an antenna, which is used for communication with other users via a network. However the antenna is in-built in the phone and hence not shown in FIG. 1.

It should be emphasised that the cell phone 10 in FIG. 1 is merely an example of a portable device in which the invention may be implemented. In addition, the invention may e.g. be used in Desktop or Laptop computers, digital cameras, smartphones, PDAs (Personal Digital Assistants), palm top computers or any other suitable portable communication device.

The attention is now directed to FIG. 2 showing the cell phone 10 in FIG. 1 connected to a cellular network 30 via a base station 32. The network 30 is typically a GSM or a GPRS network, or any other 2G, 2.5G or 2.75G network. It is of course also possible that the network is a 3G network such as a WCDMA network. However, the network in a particular embodiment does not have to be a cellular network but can be some other type of network, such as the Internet, a corporate intranet, a LAN or a wireless LAN (WLAN) or similar.

In addition, as can be seen in FIG. 2 an embodiment of the present invention may utilize or comprise a memory arrangement 33 connected to the network 30. In such cases it is preferred that the server 33 comprises a plurality of contacts each being associated with contact addresses that a user of the cell phone 10 may access and utilize for communicating with the contact in question by means of the cell phone 10. The memory arrangement 33 may e.g. be a server or similar being connected to the Internet, which in turn is connected to the network 30. Servers and other suitable memory arrangements being connected to the Internet are well known to those skilled in the art. Likewise, it is well known that e.g. a phone like the cell phone 10 can be arranged to operatively access the Internet and retrieve information from resources thereon, e.g. such as servers and other memory arrangements. This is e.g. common and well known in connection with GPRS and WCDMA networks and similar.

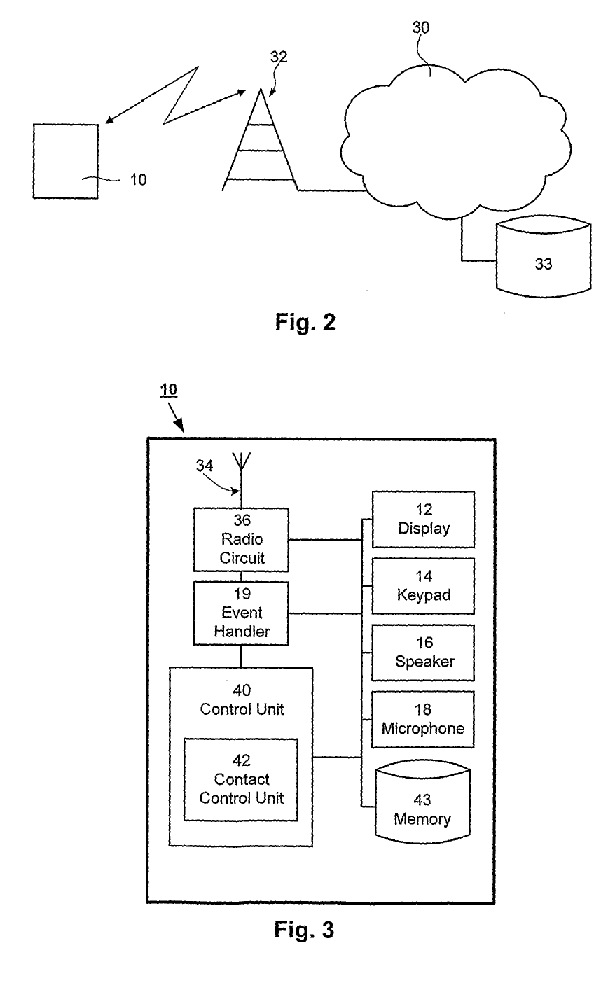

FIG. 3 is a schematic illustration of the parts of the cell phone 10 that are at relevant, but not necessarily required and/or important, for the present invention. As previously explained, it is preferred that the cell phone 10 comprises a display 12, a keypad 14, a loudspeaker 16 and a microphone 18.

It is also preferred that the phone 10 comprises an antenna 34 connected to a radio circuit 36 for enabling radio communication with a communication network, e.g. such as the network 30 in FIG. 2. In turn, the radio circuit 36 is preferably connected to an event handling unit 19 for handling such events as incoming and/or outgoing communication with external units via the network 30, e.g. incoming and/or outgoing messages such as SMS (Short Message Service), IM (Instant Messaging), MMS (Multimedia Messaging Service), e-mails and other message types such as faxes and phone calls etc.

In addition, the phone 10 is preferably provided with a memory 43 for storing data files or similar. The memory 43 may be any suitable memory that can be used in portable devices. In particular, the memory 43 is preferably arranged for operatively storing a plurality of contacts, each being associated with contact addresses that a user of the cell phone 10 may utilize for communicating with the contact in question. The contacts may e.g. be stored in an electronic address book or similar as mentioned above.

Moreover, the cell phone 10 is provided with a control unit 40 for controlling and supervising the operation of the phone 10. The control unit 40 may be implemented by means of hardware and/or software, and it may be comprised by one or several hardware units and/or software modules, e.g. one or several processor units provided with or having access to the software and hardware appropriate for the functions required by the phone 10.

As can be seen in FIG. 3, it is preferred that the control unit 40 is connected to the display 12, the key pad 14, the speaker 16, the microphone 18, the event handling unit 19, the radio unit 36 and the memory unit 43. This enables the control unit 40 to control and communicate with these units so as to e.g. exchange information and instructions with the units.

The parts and functions discussed above with reference to FIG. 3 are well known to those skilled in the art and they are also commonly used in connection with e.g. modern cellular pones and similar electronic computing an/or communicating devices. Thus, there is no need for a detailed description of these parts and functions.

Particularly interesting in connection with the exemplifying embodiment of the present invention now discussed is the contact-control-unit 42 schematically illustrated in FIG. 3. It is preferred that the contact-control-unit 42 a part of the control unit 40 and that it is arranged to operatively manage the contacts and their associated contact addresses available to the cell phone 10, e.g. one or several contacts defined in an electronic address book stored in the memory 43 of the cell phone 10 or possibly in an external memory arrangement as the server 33 shown in FIG. 2.

Being a part of the control unit 40 implies that the contact-control-unit 42 may be implemented by means of hardware and/or software, and it may be comprised by one or several hardware units and/or software modules, e.g. one or several processor units provided with or having access to the software and hardware appropriate for the functions required.

It is preferred that the contact-control-unit 42 is arranged so as to operatively retrieve, sort and present contact information. In particular, it is preferred that the contact-control-unit 42 is arranged to operatively monitor (e.g. count and store) the number of messages that are sent from and/or received by the cell phone 10 for each contact in a set of contacts being available to the cell phone 10, e.g. being stored in the memory 43. The message types may e.g. one or several of a SMS, a MMS, an IM, an e-mail, a fax or a phone call or similar sent by the cell phone 10 or received by the cell phone 10. Preferably, a specific contact address should be defined so as to enable the contact-control-unit 42 to link a specific message to a specific contact. For example, a fax number used to send a fax to a specific contact should preferably be defined as a contact address for the contact in question, which enables the contact-control-unit 42 to link the fax message to the contact in question. The same or similar is valid mutatis mutandis for other types of contact addresses.

In addition, it is preferred that the contact-control-unit 42 is arranged to operatively register (e.g. detect and store) the point in time when messages are sent from and/or received by the cell phone 10 for each contact in a set of contacts being available to the cell phone 10. To this end the contact-control-unit 42 may e.g. utilize the internal real time clock or similar, which is commonly present in cell phones and other computing devices. It should be added that such real time clocks are generally providing both time and date. This is e.g. usually required to support a calendar function in the device.

In one embodiment of the present invention it is preferred that the contact-control-unit 42 is arranged to operatively sort a set of contacts with respect to the number of times each contact has been involved in messages that are sent from and/or received by the cell phone 10. For example, a set of contacts may be sorted in descending or ascending order depending on the number of phone calls, faxes, SMSs, MMSs, IMs and/or e-mails and other messages that have been sent from the cell phone 10 to a specific contact and/or received by the cell phone 10 from a specific contact defined in an electronic address book or similar comprised by the cell phone 10, e.g. stored in the memory 43.

It is even more preferred that the contact-control-unit 42 is arranged to operatively sort a set of contacts with respect to the number of times each contact has been involved in messages that are sent from and/or received by the cell phone 10 during a determined period of time. The determined period of time may e.g. be at least a part of e.g. the last day, the last days, the last week, the last weeks, the last moth or the last months.

When the contacts have been sorted as described above it is preferred that the contact-control-unit 42 is arranged to operatively present said set of contacts on the display 12 of the cell phone 10 in a descending order depending on how many messages the particular contact have been involved in. In other words, the contact that has been involved in most messages will be presented first, whereas the contact that has been involved in most messages second to the first contact will be presented thereafter and so on. However, it is even more preferred that that the contact-control-unit 42 is arranged to operatively present said set of contacts in a descending order on the display 12 depending on how many messages the particular contact have been involved in during a determined period of time as mentioned above.

It should be emphasised that a presentation in a descending order as mentioned above may be replaced by a presentation in an ascending order.

In addition, it is generally preferred that the contact-control-unit 42 is arranged to present the sorted contacts on the display 12 by means of a list or similar from which a user of the cell phone 10 may select a contact and preferably a contact address to be used for sending a message. The selection may e.g. be performed by the user actuating the keys on the keypad 14 of the cell phone 10.

Preferably, an embodiment of the present invention has the contact-control-unit 42 arranged so as to provides the possibility of excluding one or several contacts from being involved in the set of contacts to be sorted, or involved in the sorting or involved in the presentation on the display 12. This may be particularly advantageous if one ore several contacts can be easily retrieved by alternative means, e.g. by pushing certain preprogrammed sequences of keys on the keypad 14 and/or by means of a voice command received by the microphone 18 of the cell phone 10 etc.

Before we proceed it should be emphasised that in addition to the parts and units shown in FIG. 3 there may be further parts and units present in the cell phone 10. The parts and units shown in FIG. 3 may also be connected to more parts and units than those illustrated in FIG. 3.

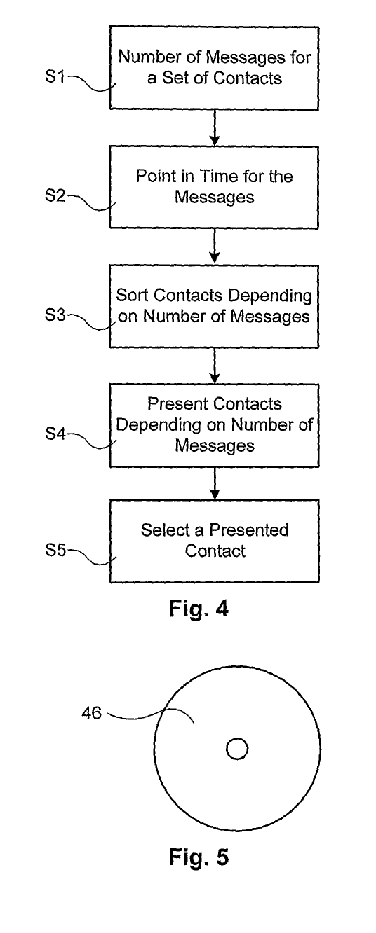

The attention is now directed to an exemplifying function of an embodiment of the present invention. The exemplifying function is described as a method with reference to the schematic flow chart in FIG. 4. The method is preferably implemented by means of the contact-control-unit 42 in the cell phone 10, as previously described with reference to FIG. 1-3.

In a first step S1 of an exemplifying method according to an embodiment of the present invention it is preferred that the number of messages that are sent from and/or received by the cell phone 10 are monitored (e.g. counted and stored) for each contact in a set of contacts being available to the cell phone 10. As mentioned above, the messages may e.g. be one or several of a SMS, a MMS, an IM, an e-mail, a fax or a phone call or similar sent by the cell phone 10 and/or received by the cell phone 10.

In a second step S2 of the exemplifying method it is preferred that the point in time when messages are sent from and/or received by the cell phone 10 are registered (e.g. detected and stored) for each contact in the set of contacts mentioned in step S1.

In a third step S3 of the exemplifying method it is preferred that the set of contacts mentioned in steps S1 and S2 are sorted with respect to the number of times each contact has been involved in messages that are sent from and/or received by the cell phone 10. For example, the set of contacts may be sorted in descending or ascending order depending on the number of phone calls, faxes, SMSs, MMSs, IMs and/or e-mails and other messages that have been sent from the cell phone 10 to a specific contact and/or received by the cell phone 10 from a specific contact being defined in an electronic address book of the cell phone 10.

It should be added that it is even more preferred that said set of contacts are sorted with respect to the number of times each contact has been involved in messages that are sent from and/or received by the cell phone 10 during a determined period of time. The determined period of time may e.g. be at least a part of e.g. the last day, the last days, the last week, the last weeks, the last moth or the last months.

In a fourth step S4 of the exemplifying method it is preferred that the set of contacts mentioned in steps S1, S2 and S3 are presented in a descending order on the display 12 of the cell phone 10 depending on how many messages the particular contact have been involved in. It is even more preferred that that the set of contacts are presented in a descending order on the display 12 depending on how many messages the particular contact have been involved in during a determined period of time as mentioned above. It should be emphasised that the presentation in a descending order may be replaced by a presentation in an ascending order. It is preferred that the contacts are presented as a list or similar on the display 12.

In a fifth step S5 of the exemplifying method it is preferred that a user of the cell phone 10 selects a contact and a contact address among the presented contacts to be used for sending a message. The selection may e.g. be performed by the user actuating the keys on the keypad 14.

In general, as previously explained, it is preferred that the contact-control-unit 42, being arranged to operatively perform the exemplifying method described above, is provided in the form of one or more processors with corresponding memory containing the appropriate software in the form of a program code or similar. However, the program code may also be provided on a data carrier such as a CD ROM disc 46 as depicted in FIG. 6 or on an insertable memory stick or similar, which will perform the invention when loaded into a computer or into a phone having suitable processing capabilities. The program code can also be downloaded remotely from a server either outside or inside the cellular network 30 or be downloaded via a computer like a PC to which the cell phone 10 or similar is temporarily connected.

It should also be added that with existing methods of operating computing devices, e.g. such as the cell phone 10 or similar, users are generally required to explicitly select a specific application to access a particular item of information or to perform a particular task, e.g. to present an address book comprising contacts on the display 12 as discussed above. Modern graphical user interfaces typically allow such applications to occupy a discrete area of the screen (commonly known as a window) which may occupy a small space on the screen or may, in full screen mode, occupy as much of it as possible. Such application windows typically overlap and are metaphorically stacked on top of each other. When a previously selected application window is obscured by a more recently selected application window, users typically lose access to the information it contained or the functionality it provided. The problems this can cause are known, and it is possible for some applications on computing devices or similar to set themselves to an ‘always on top’ mode, in which they always remain on the top of the stack and are never overlapped or obscured. Unfortunately, if the developer of such an application did not provide a means of it remaining always on top, there is no way of providing this functionality. Most applications are of this type, and a user wishing to ensure that a specific application is always visible needs to reselect and/or resize windows to restore a screen to the desired appearance.

Hence, it is advantageous to provide a computing device, e.g. such as the cell phone 10 or similar, with the facility to designate one or more windows as floating windows, in which case they always remain on top and are always visible. This may preferably be implemented on a computing device by means of an operating system which includes a control framework. It is preferred that any application window can be so designated; the user therefore is in fuller control of the information or functionality that appears on the screen of the device. This system-provided floating windows therefore enables users to define what appears on their screen, where such ‘always on top’ functionality does not have to be provided by the application developer. This makes it possible for users to be aware of specific information and have access to specific functionality wherever they are and whatever they are doing with their device. As mentioned above, a floating window may e.g. present an address book comprising contacts on the display 12. However, floating windows may present other items including but not limited to any type of news or financial information, weather information, email notification, and so on, delivered via any possible channel, e.g. via a transmission from a network as the network 30 in FIG. 2 or via a playback from a recording stored in a memory as the memory 43 schematically illustrated in FIG. 3.

The present invention has now been described with reference to exemplifying embodiments. However, the invention is not limited to the embodiments described herein. On the contrary, the full extent of the invention is only determined by the scope of the appended claims.

1. A method for retrieving contacts in a portable device being arranged to operatively communicate messages and being provided with:
access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device, which portable device is arranged to perform the method, characterized by the steps of:
monitoring the number of messages that are communicated with the device for each contact in a set of contacts among said plurality of contacts;
sorting said set of contacts with respect to the number of times each contact has been involved in the communication of a message;
presenting the sorted set of contacts on the presentation arrangement.

2. The method in claim 1 wherein the portable device is provided with an input arrangement and the method comprises the steps of selecting a contact among the presented contacts by receiving input from the input arrangement being actuated by a user of the portable device.

3. The method in claim 1 comprising the steps of registering the point in time when messages are communicated with the device for each contact in the set of contacts, and sorting said set of contacts with respect to the number of times each contact has been involved in the communication of a message during a determined period of time.

4. The method in claim 1 wherein the messages that are communicated with the device are sent from the device.

5. The method in claim 1 wherein the messages that are communicated with the device are sent from the device and/or received by the device.

6. The method in claim 1 wherein the messages that are communicated with the device are of at least two different types.

7. The method in claim 6 wherein the messages that are communicated with the device are of at least two different types among: a Short Message Service message (SMS)₁ an Instant Messaging message (IM), an Multimedia Messaging Service (MMS), an e-mail message, a fax message or a phone call message.

8. The method in claim 1 wherein one or several contacts among said plurality of contacts are excluded from said set of contacts, or at least from one of said sorting or said presenting.

9. The method in claim 1 wherein the sorted set of contacts are presented in ascending or descending order depending on the number of messages that are communicated with the device for each contact.

10. A portable device being arranged to operatively communicate messages and being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device, which portable device is arranged to retrieve contacts by being operatively arranged to:
monitor the number of messages that are communicated with the device for each contact in a set of contacts among said plurality of contacts;
sort said set of contacts with respect to the number of times each contact has been involved in the communication of a message;
present the sorted set of contacts on the presentation arrangement.

11. The portable device in claim 10 wherein the portable device is provided with an input arrangement, and wherein the portable device is arranged to operatively select a contact among the presented contacts by receiving input from the input arrangement being actuated by a user of the portable device.

12. The portable device in claim 10 wherein the portable device is arranged to operatively register the point in time when messages are communicated with the device for each contact in the set of contacts, and to operatively sort the set of contacts with respect to the number of times each contact has been involved in the communication of a message during a determined period of time.

13. The portable device in claim 10 wherein the portable device is arranged to operatively communicate messages by sending messages.

14. The portable device in claim 10 wherein the portable device is arranged to operatively communicate messages by sending messages and/or receiving messages.

15. The portable device in claim 10 wherein the portable device is arranged to operatively communicate messages of at least two different types.

16. The portable device in claim 15 wherein the portable device is arranged to operatively communicate messages of at least two different types among: a Short Message Service message (SMS), an Instant Messaging message (IM), an Multimedia Messaging Service (MMS), an e-mail message, a fax message or a phone call message.

17. The portable device in claim 10 wherein the portable device is arranged to operatively exclude one or several contacts among said plurality of contacts from said set of contacts, or at least from one of said sorting or said presenting.

18. The portable device claim 10 wherein the portable device is arranged to operatively present the sorted set of contacts in ascending or descending order depending on the number of messages that are communicated with the device for each contact.

19. A computer program product stored on a computer usable medium, comprising readable program means for causing a portable device to execute, when said program means is loaded in the portable device being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device,
the steps of:
monitoring the number of messages that are communicated with the device for each contact in a set of contacts among said plurality of contacts;
sorting said set of contacts with respect to the number of times each contact has been involved in the communication of a message;
presenting the sorted set of contacts on the presentation arrangement.

20. A computer program element having a program recorded thereon, where the program is to make a portable device to execute, when said program means is loaded in the portable device being provided with: access to a memory arrangement comprising a plurality of contacts, each being associated with one or several contact addresses for enabling a user of the portable device to communicate messages with the contact in question; a presentation arrangement for presenting contacts; and at least one control unit for controlling the operation of the portable device,
the steps of:
monitoring the number of messages that are communicated with the device for each contact in a set of contacts among said plurality of contacts;
sorting said set of contacts with respect to the number of times each contact has been involved in the communication of a message;
presenting the sorted set of contacts on the presentation arrangement.
